(19) United States
(12) Patent Application Publication
(10) Pub. No.: US 2014/0010317 A1
(43) Pub. Date: Jan. 9, 2014

(54) ELECTRONIC CIRCUIT AND COMMUNICATION METHOD

(71) Applicant: FUJITSU LIMITED, Kawasaki-shi (JP)

(72) Inventors: Yukihiko OSHIKIRI, Sapporo (JP); Akio Sasaki, Ebetsu (JP)

(21) Appl. No.: 13/931,448

(22) Filed: Jun. 28, 2013

(30) Foreign Application Priority Data
Jul. 6, 2012 (JP) 2012-152378

(51) Int. Cl. H04L 7/00

(52) U.S. Cl. CPC H04L 7/0012
USPC 375/259

(57) ABSTRACT

An electronic circuit includes: a memory, and a processor coupled to the memory, configured to sample a transmission signal at an edge timing of a pulse of a clock signal for synchronizing with a counterpart electronic circuit, transmit a sampled transmission signal to the counterpart electronic circuit, receive a response signal sent from the counterpart electronic circuit in response to the sampled transmission signal, and set any one of a rising edge and a falling edge of the clock signal as an edge trigger for a sampling timing of the sampling according to a reception result of the response signal.

### CROSS-REFERENCE TO RELATED APPLICATIONS

This application is based upon and claims the benefit of priority of the prior Japanese Patent Application No. 2012-152378 filed on Jul. 6, 2012, the entire contents of which are incorporated herein by reference.

### FIELD

The present disclosure relates to a synchronous communication between electronic circuits.

### BACKGROUND

DigRF v4 (digital radio frequency version 4) is known as an exemplary communication interface for performing a synchronous communication between a plurality of electronic circuits. DigRF v4, standardized by the MIPI (mobile industry processor interface), is a communication interface between a baseband IC (integrated circuit) and an RFIC (radio frequency IC) used in, for example, a mobile phone.

As an associated technology, a radio circuit that is configured to receive a loopback request command from a digital baseband circuit is known. Responding to the reception of the loopback request command, the radio circuit instantly returns a confirmation command back to the digital baseband circuit, thereby facilitating the determination at the digital baseband circuit on the latency of a communication link between the digital baseband circuit and the radio circuit.

Further, there is known an automatic phase inverting circuit provided with an inverter circuit that generates an inverted-phase clock signal and a received data change point detecting circuit that detects a change point of received data. The automatic phase inverting circuit is provided with an in-phase clock signal determining circuit that determines the operational margin of the phase of an in-phase clock signal during the read-in operation of the received data, and outputs the determination result through a predetermined protection circuit. The automatic phase inverting circuit is also provided with an inverted phase clock signal determining circuit that determines the operational margin of the phase of an inverted-phase clock signal during the read-in operation of the received data, and outputs the determination result through a predetermined protection circuit. The automatic phase inverting circuit is further provided with a selection signal generating circuit that generates a selection signal of a clock signal and a clock signal selecting circuit that selectively outputs an in-phase clock signal or an inverted-phase clock signal according to the logic of the selection signal. These technologies are disclosed in, for example, Japanese National Publication of International Patent Application No. 2011-517183, and Japanese Laid-open Patent Publication No. 2002-232402.

### SUMMARY

According to an aspect of the present disclosure, there is provided an electronic circuit including a memory, and a processor coupled to the memory, configured to sample a transmission signal at an edge timing of a pulse of a clock signal for synchronizing with a counterpart electronic circuit, transmit a sampled transmission signal to the counterpart electronic circuit, receive a response signal sent from the counterpart electronic circuit in response to the sampled transmission signal, and set any one of a rising edge and a falling edge of the clock signal as an edge trigger for a sampling timing of the sampling according to a reception result of the response signal.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is an explanatory view illustrating the hardware configuration of an electronic circuit according to a first exemplary embodiment.

FIG. 2 is a functional configuration view illustrating a baseband IC according to the first exemplary embodiment.

FIG. 3 is a view schematically illustrating an edge trigger determination method.

FIGS. 4A to 4E are explanatory views illustrating a loopback signal in a case where a rising edge is used as an edge trigger.

FIGS. 5A to 5E are explanatory views illustrating a loopback signal in a case where a falling edge is used as an edge trigger.

FIG. 6 is a flow chart illustrating a first example of an edge trigger determination method.

FIG. 7 is an explanatory view illustrating a first example of a signal sequence between ICs.

FIG. 8 is a view schematically illustrating a modified example of an edge trigger determination method.

FIG. 9 is an explanatory view illustrating the hardware configuration of an electronic circuit according to a second exemplary embodiment.

FIG. 10 is a functional configuration view illustrating a baseband IC according to the second exemplary embodiment.

FIGS. 11A and 11B are explanatory views illustrating an example of a method of determining a deviation amount from the center of a sampling timing range where a sampling error does not occur.

FIG. 12 is a flow chart illustrating a second example of an edge trigger determination method.

FIG. 13 is an explanatory view illustrating a second example of a signal sequence between ICs.

### DESCRIPTION OF EMBODIMENTS

In a synchronous communication performed between electronic circuits of a related art, there is a case where a phase difference occurs between the edge of a clock signal used in synchronization and the edge of a reception signal. For example, when the delay of a transmission signal from a first electronic circuit to a second electronic circuit does not correspond to the phase delay of a clock signal in the second electronic circuit compared with the phase of a clock signal in the first electronic circuit, there occurs a phase difference between the edge of the reception signal and the edge of the clock signal.

For example, in DigRF v4, when a clock signal is transmitted from a radio frequency IC to a baseband IC, the phase of a clock signal in the radio frequency IC is delayed compared with the phase of a clock in the baseband IC. In contrast, the phase of an uplink signal received at the radio frequency IC from the baseband IC is delayed compared with the phase in the baseband IC.

In a case where a phase difference occurs between the edge of a clock signal and the edge of a reception signal, there is a concern that a sampling error may occur in a signal due to, for example, the following factors.

(1) The amount of signal delay between electronic circuits varies depending on an individual device, a production lot or an apparatus design. Thus, the phase difference of the edges between the clock signal and the reception signal also depends on these factors. Accordingly, even if the sampling timing of the reception signal has been optimized during the design of a platform, there may exist a case where a sampling error occurs because the edge of the sampling timing becomes closed to the edge of the reception signal.

(2) There is a tendency that the time period for set-up and holding during which the reception signal is sampled also depends on an individual device or a production lot. Thus, there is a case where a sampling error occurs because the edge of the reception signal occurs during the time period for set-up and holding.

The technologies disclosed in the exemplary embodiment, which will be described below, may reduce a sampling error in a synchronous communication performed between electronic circuits.

### 1. First Exemplary Embodiment

1.1. Hardware Configuration

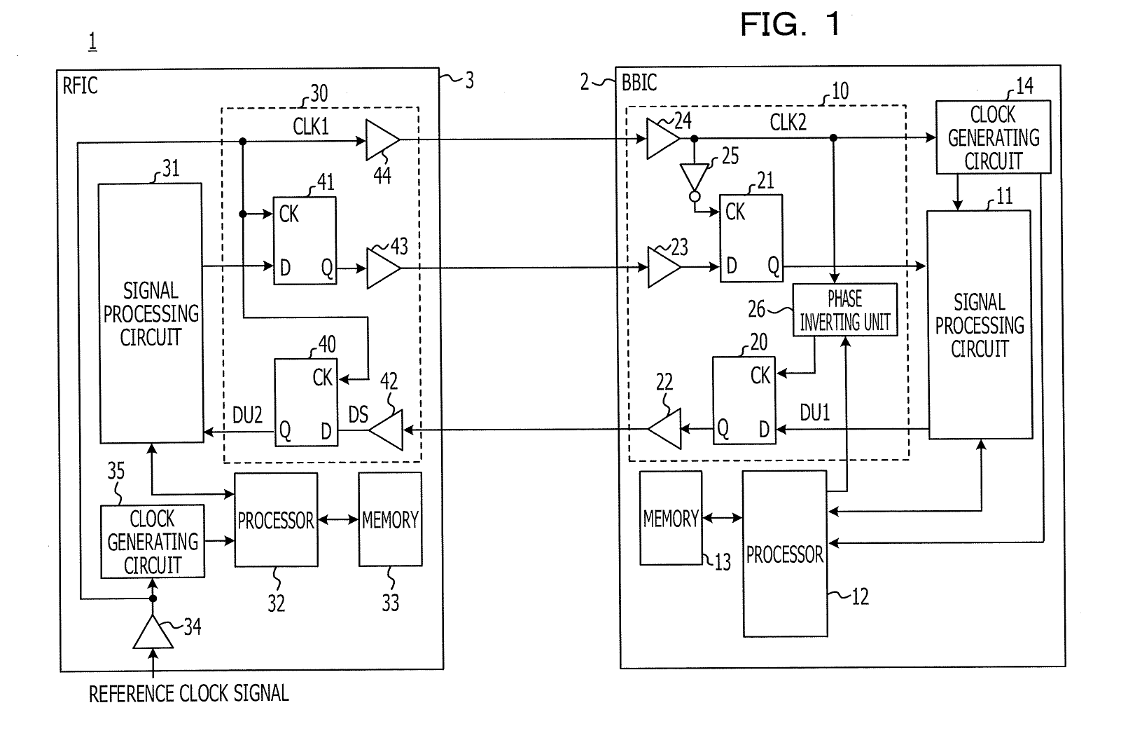

Hereinafter, an exemplary embodiment will be described with reference to accompanying drawings. FIG. 1 is an explanatory view illustrating the hardware configuration of an electronic circuit according to a first exemplary embodiment. An electronic circuit 1 is provided with a baseband IC 2 that processes a baseband signal of a mobile radio communication, and a radio frequency IC 3 that processes a radio frequency signal. Hereinafter, the electronic circuit 1 will be described using an example where a baseband IC and a radio frequency IC perform a synchronous communication according to DigRF v4. In particular, the device and the method disclosed in the present application may also be applied to any electronic circuit where the communication between circuit modules is performed based on another type of communication interface, as long as the electronic circuit is configured to perform a synchronous communication between the circuit modules. Also, in the accompanying drawings and the following description, a baseband and a radio frequency may be referred to as a “BB” and an “RE”, respectively.

The BBIC 2 is provided with an interface circuit 10, a signal processing circuit 11, a processor 12, a memory 13, and a clock generating circuit 14. The interface circuit 10 performs a signal processing for communication to/from the RFIC 3 in accordance with DigRF v4. For this reason, the interface circuit 10 is provided with D-type flip-flops 20, 21, buffers 22, 23, 24, an inverter 25 and a phase inverting unit 26. Also, in the following description, the D-type flip-flop may be referred to as a “FF”.

The FF 20 samples uplink data or a command on the RFIC 3 input from the signal processing circuit 11, and outputs the uplink data or the command through an output terminal Q. The FF 20 uses the edge timing of a clock signal received from the RFIC 3 as a triggering edge of a sampling timing, (hereinafter, the triggering edge of a sampling timing is referred to as “an edge trigger”). The signal output from the FF 20 is output to the RFIC 3 through the buffer 22. Also, the uplink data or the command on the RFIC 3 input to the D terminal of the FF 20 may be referred to as “uplink data DU1” or “DU1”, respectively, in the following description and the accompanying drawings.

The RFIC 3 transmits a response signal responding to the command transmitted to the RFIC 3 or downlink data to the BBIC 2. The downlink data or the response signal is input to the FF 21 via the buffer 23. The FF 21 samples the downlink data or the response signal at the timing of a falling edge of the clock signal received from the RFIC 3, and outputs the downlink data or the response signal to the signal processing circuit 11.

The buffer 24 receives the clock signal transmitted from the RFIC 3 to the BBIC 2. The clock signal is input to the clock generating circuit 14 and the phase inverting unit 26. Also, due to the transmission delay between the RFIC 3 and the BBIC 2, there exists a phase difference between the clock signal within the RFIC 3 and the clock signal within the BBIC 2. Accordingly, in the following description and the accompanying drawings, the clock signal within the RFIC 3 may be referred to as “CLK1”, and the clock signal within the BBIC 2 may be referred to as “CLK2”.

The inverter 25 inverts the phase of the clock signal CLK2 and inputs the inverted clock signal CLK2 to a clock terminal CK of the FF21 so that the FF 21 may sample the downlink data or the response signal at the falling edge of the clock signal CLK2. The signal delay of the signal transmitted from the RFIC 3 to the BBIC 2 is nearly the same or similar to that of the clock signal. In the RFIC 3, a transmission signal is sampled at the rising edge of the clock signal, and in the BBIC 2, a reception signal is sampled at the falling edge of the clock signal, so that the reception signal is sampled near the center of a signal change point, thereby reducing the sampling error of the reception signal.

The phase inverting unit 26 inverts the phase of the clock signal CLK2 according to the instruction of the processor 12, and inputs any one of an in-phase signal and an inverted phase signal of the clock signal CLK2 to the clock terminal CK of the FF 20. By the inverting the phase of the clock signal CLK2, the edge trigger for the sampling timing of the FF 20 is inverted between the rising edge and the falling edge of the clock signal CLK2.

The signal processing circuit 11 performs a signal processing on the uplink data and the downlink data transmitted/received via the interface circuit 10. Also, the signal processing circuit 11 transmits the command onto the RFIC 3 according to the instruction of the processor 12. The command transmitted from the BBIC 2 to the RFIC 3 may include a command that instructs the RFIC 3 to transmit a response signal to the BBIC 2. Such a command may be, for example, a loopback command that instructs the RFIC 3 to return the signal transmitted from the BBIC 2, as it is. One example of the loopback command is an interface control logical channel (ICLC) (91h) command (Turn Logic-Level Frame Loopback On) that is provided in DigRF v4.

Another example of the command that instructs the RFIC 3 to transmit the response signal to the BBIC 2 may be a Ping command that instructs a well-known response signal to be transmitted. Examples of the Ping command and the well-known response signal may be an ICLC (94h) command (Ping Request) and an ICLC (95h) command (Ping Response), respectively, provided in DigRF v4.

Also, the command to be transmitted from the BBIC 2 to the RFIC 3 may include a start-up command that starts the RFIC 3 so that the RFIC 3 may execute the ICLC (91h) command or the ICLC (94h) command.

The processor 12 performs an operation control of the BBIC 2 or an operation of determining the edge trigger in the sampling of the FF 20, which will be described below. The operation of determining the edge trigger will be described below. In the memory 13, a control program for a signal processing performed by the processor 12 or data used during the execution of the program is stored. The memory 13 may include, for example, a non-volatile memory or a read only memory (ROM), which is configured to store a computer program or data. Also, in the memory 13, a program that is currently being executed in the processor 12, or data that is temporarily used by the program is stored. The memory 13 may include a random access memory (RAM). The clock generating circuit 14 generates an operating clock of the signal processing circuit 11 and the processor 12 based on the clock signal CLK2.

The RFIC 3 is provided with an interface circuit 30, a signal processing circuit 31, a processor 32, a memory 33, a buffer 34, and a clock generating circuit 35. The interface circuit 30 performs a signal processing for communication to/from the BBIC 2 in accordance with DigRF v4. For this reason, the interface circuit 30 is provided with FFs 40, 41 and buffers 42, 43, 44.

The uplink data or the command, which is transmitted from the BBIC 2, is input to the FF 40 via the buffer 42. The FF 40 samples these signals at the rising edge of the clock signal CLK1 and outputs them to the signal processing circuit 31. Also, the uplink data or the command which has been received by the RFIC 3 but not yet sampled by the FF 40 may be referred to as “uplink signal DS” or “DS” in the following description and the accompanying drawings. Also, the uplink data or the command which has been sampled by the FF 40 may be referred to as “uplink data DU2” or “DU2” in the following description and the accompanying drawings.

The FF 41 samples the downlink data received from the signal processing circuit 31 or the response signal to the command received from the BBIC 2 at the rising edge of the clock signal CLK1, and outputs the sampled downlink data or the sampled response signal through the output terminal Q. The signal output from the FF 41 is output to the BBIC 2 through the buffer 43.

The signal processing circuit 31 performs a signal processing on the uplink data and the downlink data transmitted/received via the interface circuit 30. Also, the signal processing circuit 31 performs a signal processing according to the command transmitted from the BBIC 2. For example, when the loopback command is received, the signal processing circuit 31 returns the signal transmitted from the BBIC 2 back to the BBIC 2 through the downlink. Also, for example, when the Ping command is received, the signal processing circuit 31 sends the well-known response signal back to the BBIC 2 through the downlink.

The processor 32 performs an operation control of the RFIC 3. In the memory 33, a control program for a signal processing performed by the processor 32 or data used during the execution of the program is stored. The memory 33 may include, for example, a non-volatile memory or a ROM, which is configured to store a computer program or data. Also, a program that is currently being executed in the processor 32, or data that is temporarily used by the program is stored in the memory 33. The memory 33 may include a RAM.

The clock generating circuit 35 generates an operating clock of the signal processing circuit 31 and the processor 32 based on a reference clock signal received through the buffer 34. The reference clock signal received through the buffer 34 is used as the clock signal CLK1 in sampling by the FFs 40 and 41. Also, the reference clock signal received through the buffer 34 is transmitted to the BBIC 2 through the buffer 44 of the interface circuit 30, and is used as the clock signal CLK2.

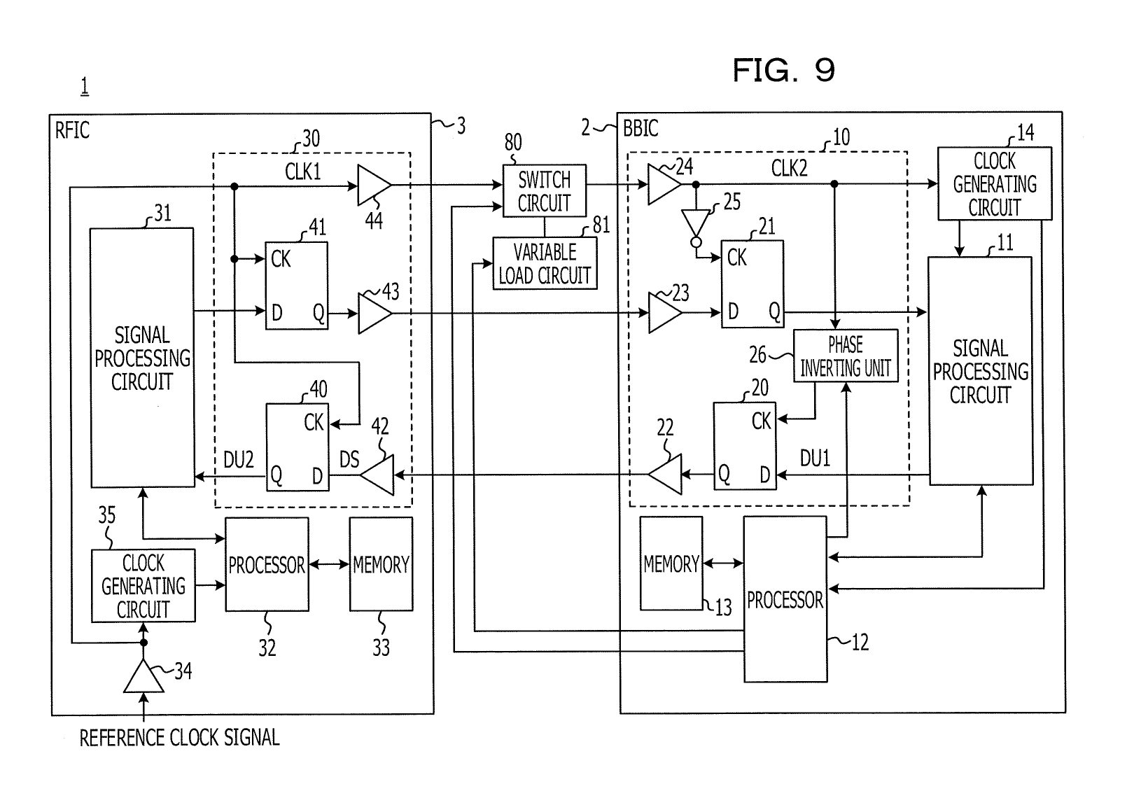

Also, the hardware configuration illustrated in FIG. 1 is only an example for describing the present exemplary embodiment. The electronic circuit disclosed in the present application may employ any other hardware configurations as long as the electronic circuit is capable of performing the operation as described below. Further, the same applies to the hardware configuration illustrated in FIG. 9.

1.2. Functional Configuration

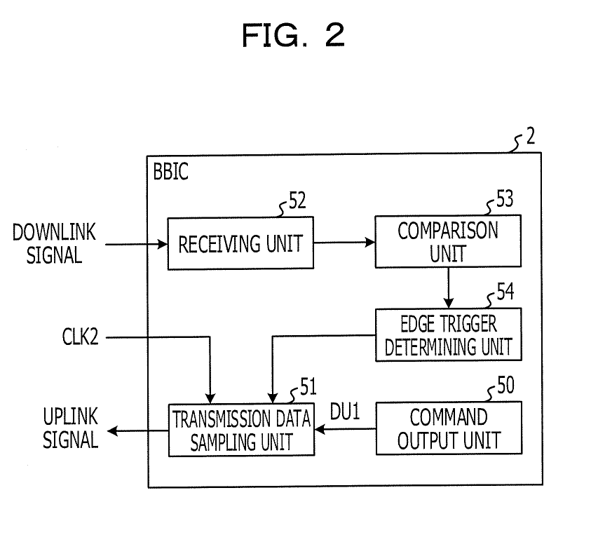

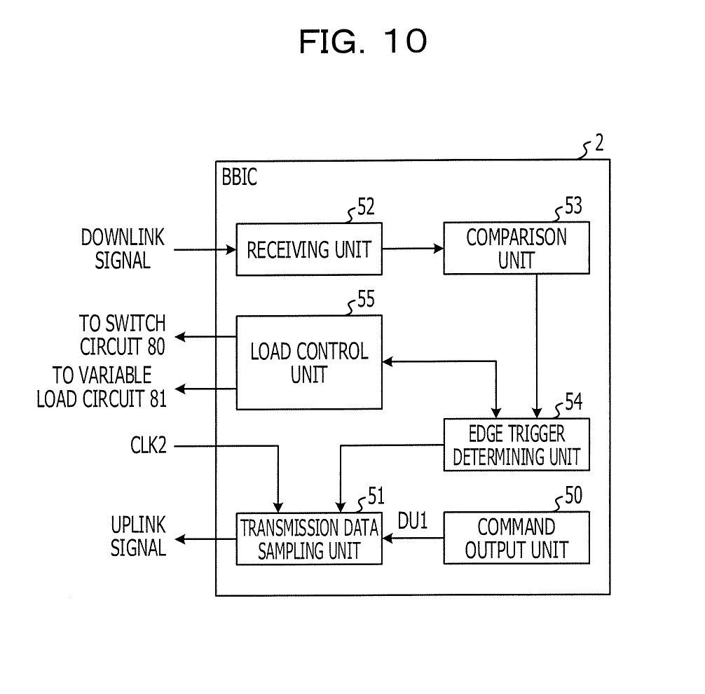

The functions to be realized by the above described hardware configuration will be described. FIG. 2 is a functional configuration view illustrating the BBIC 2 according to the first exemplary embodiment. Also, the functional configuration view in FIG. 2 illustrates the BBIC 2 by focusing on a configuration related to the function to be described below in the present specification. The BBIC 2 may include other components besides the illustrated components. The same applies to the functional configuration view illustrated in FIG. 10.

The BBIC 2 is provided with a command output unit 50, a transmission data sampling unit 51, a receiving unit 52, a comparison unit 53, and an edge trigger determining unit 54. The command output unit 50 outputs the start-up command that starts the RFIC 3 to the transmission data sampling unit 51.

Also, as the command for the RFIC 3, the command output unit 50 outputs the command to the transmission data sampling unit 51 instructing the response signal to be transmitted to the BBIC 2. The command may be the ICLC (91h) command described above. Subsequently to the ICLC (91h) command, the command output unit 50 outputs a frame that stores a predetermined pattern signal to the transmission data sampling unit 51.

The transmission data sampling unit 51 samples and transmits the command, the frame, and the uplink data output by the command output unit 50, to the RFIC 3. Herein, the transmission data sampling unit 51 uses any one of the rising edge and the falling edge of the clock signal CLK2 determined by the edge trigger determining unit 54 as the edge trigger for the sampling timing.

The receiving unit 52 receives the downlink data from the RFIC 3. Also, the receiving unit 52 receives a loopback signal returned by the RFIC 3. The loopback signal is the frame initially transmitted by the BBIC 2 after the ICLC (91h) command, which is sent out and returned by the RFIC 3 as it is. The comparison unit 53 compares the pattern signal included in the transmitted frame to a signal included in the loopback signal.

The edge trigger determining unit 54 determines one of the edges of the rising edge and the falling edge of the clock signal CLK2 to be used as the edge trigger for the sampling timing with respect to the transmission data sampling unit 51. The edge trigger determining unit 54 determines one of the edges to be used as the edge trigger based on the comparison result from the comparison unit 53 determined when each of the rising edge and the falling edge is used as the edge trigger.

Also, the operation of the command output unit 50 as described above is performed by the cooperation of the signal processing circuit 11 and the processor 12 as illustrated in FIG. 1. Also, the operation of the transmission data sampling unit 51 as described above is performed by the FF 20 and the phase inverting unit 26. The operation of the receiving unit 52 as described above is performed by the FF 21. The operation of the comparison unit 53 and the edge trigger determining unit 54 as described above is performed by the processor 12.

1.3. Operation

Descriptions will now be made regarding the operation of the BBIC 2. When power is applied to the electronic circuit 1, before the start of a predetermined start-up sequence between the BBIC 2 and the RFIC 3, the BBIC 2 transmits the start-up command that starts the RFIC 3 and thus allows the RFIC 3 to execute the ICLC command. Then, the BBIC 2 determines any one of the rising edge and the falling edge of the clock signal CLK2 as the edge trigger for the sampling in the transmission data sampling unit 51.

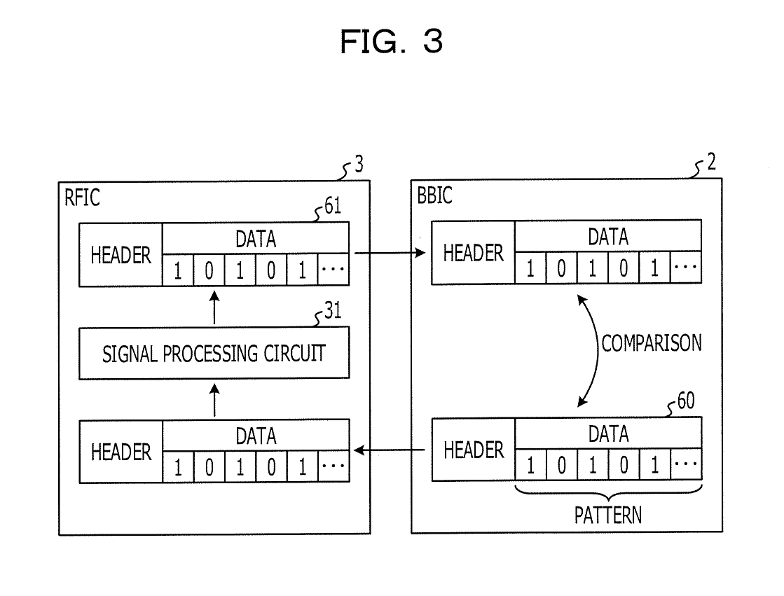

FIG. 3 is a view schematically illustrating an example of a method for determining an edge trigger. The command output unit 50 of the BBIC 2 transmits a frame 60 including a predetermined pattern such as, for example, “10101 . . . ” to the RFIC 3 after transmitting the ICLC 91h command. Then, upon receiving the ICLC 91h command, the signal processing circuit 31 of the RFIC 3 transmits a loopback signal 61 that is the same as the received frame 60 to the BBIC 2. The comparison unit 53 compares the respective pattern signals “10101 . . . ” included in each of the loopback signal 61 and the frame 60. The BBIC 2 performs the transmission of the ICLC (91h) command and the frame 60, and the comparison of the pattern signals in each of cases where the rising edge is used as the edge trigger and the falling edge is used as the edge trigger.

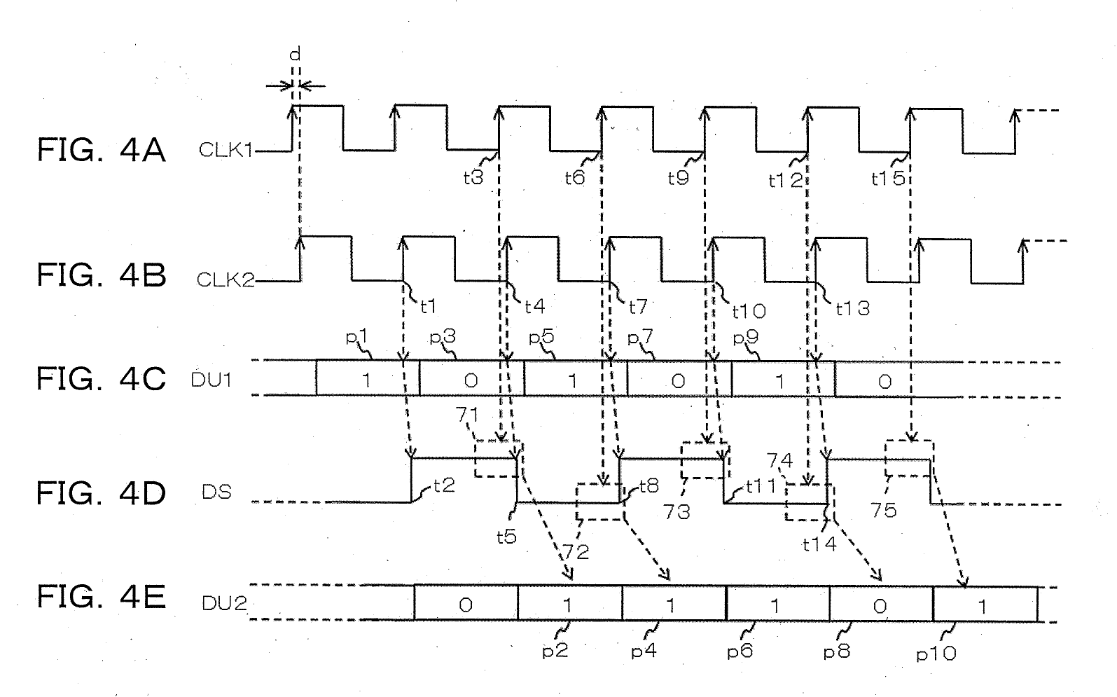

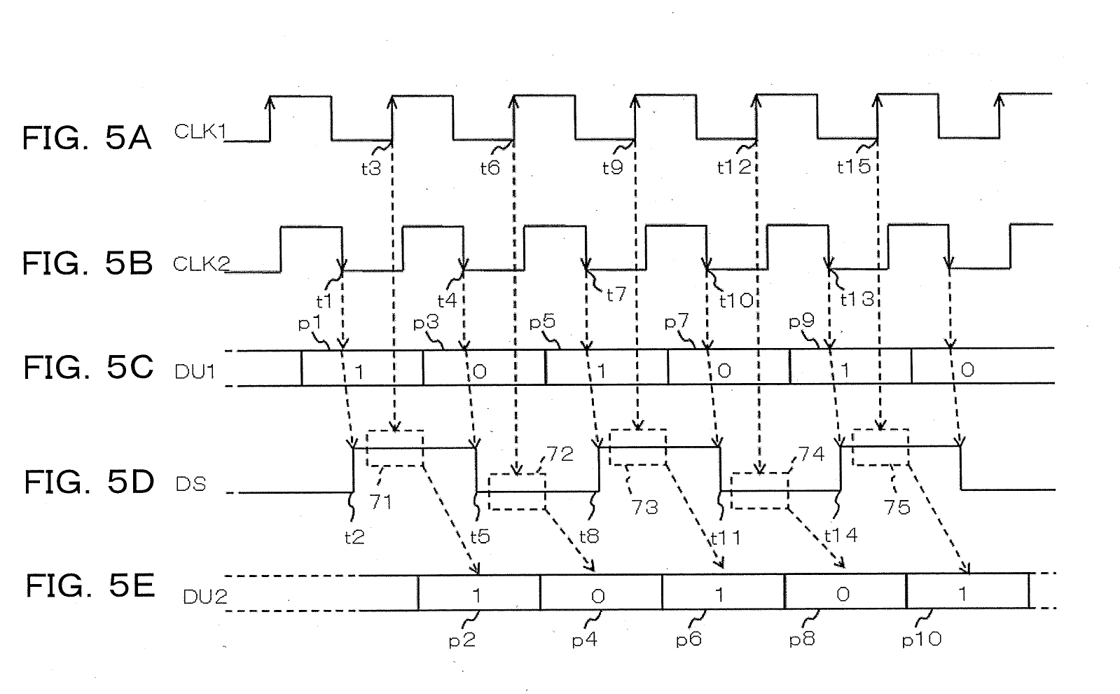

Referring to FIGS. 4A to 4E and FIGS. 5A to 5E, descriptions will be made regarding the change in the loopback signal according to the difference in the sampling between the rising edge and the falling edge in the transmission data sampling unit 51. In a case where the rising edge is used as the edge trigger, time charts of the clock signals CLK1 and CLK2, the uplink data DU1, the uplink signal DS and the uplink data DU2 are illustrated in FIGS. 4A to 4E, respectively.

Points of time t1, t4, t7, t10 and t13 indicate the edge timings of the rising edge of the clock signal CLK2 in the BBIC 2, respectively. Points of time t3, t6, t9, t12 and t15 indicate the edge timings of the rising edge of the clock signal CLK1 in the RFIC 3. The clock signal CLK2 is delayed compared with the clock signal CLK1 by a period of time d.

Periods of time p1, p3, p5, p7 and p9, respectively, indicate the periods of time when the first, second, third, fourth, and fifth bits of the predetermined pattern “10101” stored in the frame 60 are input to the transmission data sampling unit 51. The first, second, third, fourth, and fifth bits of the predetermined pattern, respectively, are sampled at the rising edge timings t1, t4, t7, t10 and t13 of the clock signal CLK2 and transmitted to the RFIC 3.

In the uplink signal DS received by the RFIC 3, the signal changes corresponding to the first, second, third, fourth, and fifth bits of the predetermined pattern occur at points of time t2, t5, t8, t11 and t14. The signal values that have been changed at these points of time, respectively, are sampled at the rising edge timings t3, t6, t9, t12 and t15 of the clock signal CLK1.

Herein, periods of time for set-up and holding for the sampling of the uplink signal DS in the RFIC 3 are taken into consideration. Each of the rectangles 71, 72, 73, 74, and 75 indicates a time period for set-up and holding at the sampling timings t3, t6, t9, t12 and t15, respectively. In the illustrated example, when the rising edge of the clock signal CLK2 is used at the sampling timing in the transmission data sampling unit 51, a signal change is caused in the uplink signal DS within the periods of time for set-up and holding. Accordingly, a sampling error may easily occur.

Periods of time p2, p4, p6, p8 and p10, respectively, indicate periods of time when the predetermined pattern sampled at the sampling timings t3, t6, t9, t12 and t15 is output. In the present example, an error occurs in which the signal “0” sampled at the point of time t4 is detected as “1”, thereby changing a received pattern into “11101”.

Next, in a case where the falling edge is used as the edge trigger, time charts of the clock signals CLK1 and CLK2, the uplink data DU1, the uplink signal DS and the uplink data DU2 are illustrated in FIGS. 5A to 5E, respectively.

In the illustrated example, when the falling edge is used, signal change points t2, t5, t8, t11 and t14 of the uplink signal DS becomes further away from sampling timings t3, t6, t9, t12 and t15. As a result, a signal change of the uplink signal DS does not occur in periods of time for set-up and holding 71, 72, 73, 74 and 75, making a sampling error difficult to occur.

The edge trigger determining unit 54 of the BBIC 2 determines the rising edge as the edge trigger in a case when the pattern signals are matched when the rising edge is used as the edge trigger, and when the pattern signals are not matched when the falling edge is used as the edge trigger. The edge trigger determining unit 54 determines the falling edge as the edge trigger in a case when the pattern signals are matched when the falling edge is used as the edge trigger, and when the pattern signals are not matched when the rising edge is used as the edge trigger.

If the pattern signals are matched in both cases where the rising edge is used and the falling edge is used, the edge trigger determining unit 54 determines any one of the rising edge and falling edge as the edge trigger. Any one of the rising edge and the falling edge may be determined in advance as an edge to be used preferentially. Also, the frame transmission and the comparison may be performed in plural times on each of the rising edge and the falling edge, and an edge having more matching patterns may be selected as the edge trigger.

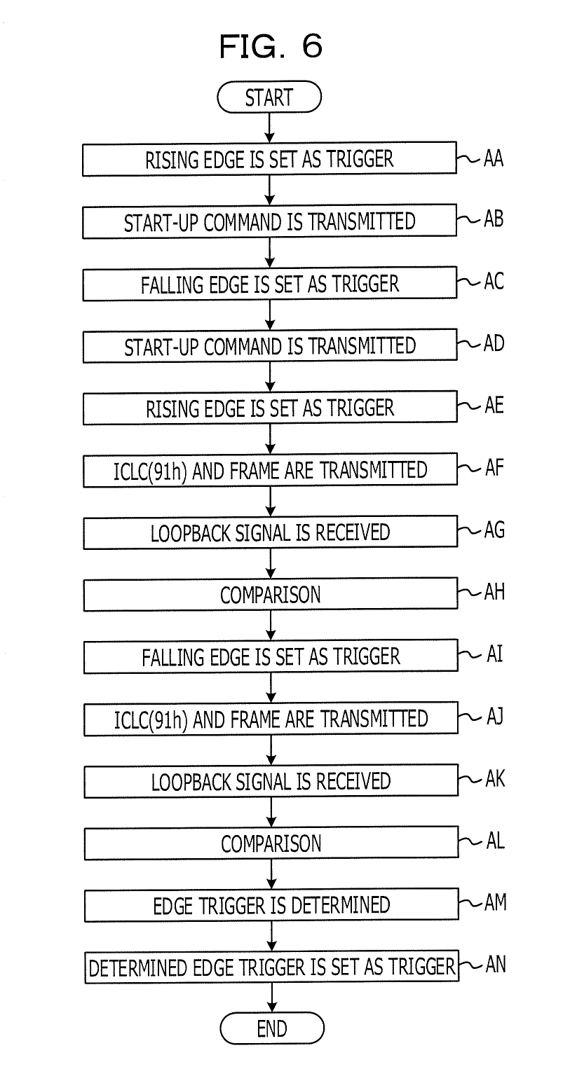

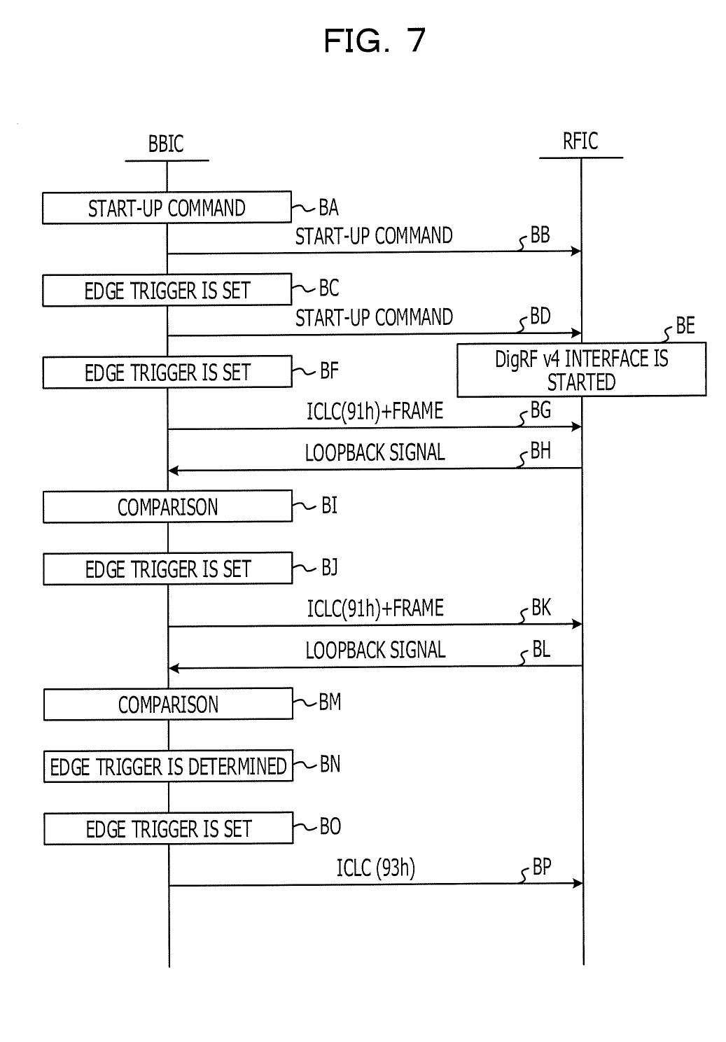

FIG. 6 is a flow chart illustrating a first example of an edge trigger determination method. A series of operations described with reference to FIG. 6 may be understood as a method including a plurality of steps. In this case, an “operation” may alternatively be read as a “step”. The same applies to the operation illustrated in FIGS. 7, 12 and 13.

In the operation AA, the edge trigger determining unit 54 sets the rising edge of the clock signal CLK2, as the edge trigger of the transmission data sampling unit 51. In the operation AB, the command output unit 50 transmits the start-up command to the RFIC 3.

In the operation AC, the edge trigger determining unit 54 sets the falling edge of the clock signal CLK2, as the edge trigger of the transmission data sampling unit 51. In the operation AD, the command output unit 50 transmits the start-up command to the RFIC 3. The start-up command is transmitted in both cases where the rising edge is used as the edge trigger and the falling edge is used as the edge trigger. Thus, even if it is not apparent which edge to be used as the edge trigger causes the sampling error, it is possible to more certainly start the RFIC 3.

In the operation AE, the edge trigger determining unit 54 sets the rising edge of the clock signal CLK2 as the edge trigger of the transmission data sampling unit 51. In the operation AF, the command output unit 50 transmits the ICLC (91h) command to the RFIC 3. After the ICLC (91h) command is sent out, the command output unit 50 transmits the frame including the predetermined pattern to the RFIC 3.

In the operation AG, the receiving unit 52 receives the loopback signal transmitted from the RFIC 3. In the operation AH, the comparison unit 53 compares the pattern included in the loopback signal to the pattern included in the frame.

In the operation AI, the edge trigger determining unit 54 sets the falling edge of the clock signal CLK2 as the edge trigger of the transmission data sampling unit 51. The operations AJ to AL are the same as the operations AF to AH. In the operation AM, the edge trigger determining unit 54 determines an edge to be used as the edge trigger based on the comparison result of the comparison unit 53 in the operations AH and AL. In the operation AN, the edge trigger determining unit 54 sets the edge determined in the operation AM as the edge trigger of the transmission data sampling unit 51.

FIG. 7 is an explanatory view illustrating a first example of a signal sequence between ICs. In the operation BA, the edge trigger determining unit 54 sets the rising edge of the clock signal CLK2 as the edge trigger of the transmission data sampling unit 51. In the operation BB, the command output unit 50 transmits the start-up command to the RFIC 3.

In the operation BC, the edge trigger determining unit 54 sets the falling edge of the clock signal CLK2 as the edge trigger of the transmission data sampling unit 51. In the operation BD, the command output unit 50 transmits the start-up command to the RFIC 3. By at least any one of the start-up commands transmitted in the operations BB and BD, the RFIC 3 is started and placed in an executable state to execute the ICLC command in the operation BE.

In the operation BF, the edge trigger determining unit 54 sets the rising edge of the clock signal CLK2 as the edge trigger of the transmission data sampling unit 51. In the operation BG, the command output unit 50 transmits the ICLC 91h command and the frame including the predetermined pattern to the RFIC 3. In the operation BH, the RFIC 3 transmits the received frame, as it is, as the loopback signal. In the operation BI, the comparison unit 53 compares the pattern included in the frame to the pattern included in the loopback signal.

In the operation BJ, the edge trigger determining unit 54 sets the falling edge of clock signal CLK2 as the edge trigger of the transmission data sampling unit 51. In the operation BK, the command output unit 50 transmits the ICLC (91h) command and the frame including the predetermined pattern to the RFIC 3. In the operation BL, the RFIC 3 transmits the received frame as it is, as the loopback signal. In the operation BM, the comparison unit 53 compares the pattern included in the frame to the pattern included in the loopback signal.

In the operation BN, the edge trigger determining unit 54 determines an edge to be used as the edge trigger based on the comparison result of the comparison unit 53 in the operations BI and BM. In the operation BO, the edge trigger determining unit 54 sets the edge determined in the operation BN as the edge trigger of the transmission data sampling unit 51. In the operation BP, the command output unit 50 transmits an ICLC (93h) command to the RFIC 3 stopping the transmission of the loopback signal according to the ICLC (91h) command.

1.4. Effect

By inverting the edge trigger for the sampling of a transmitter side circuit between the rising edge and the falling edge of the clock signal, it is possible to reduce the sampling error that may be caused by a gap between a point of time of sampling and a point of time of edge generation of the reception signal in a receiver side circuit.

Also, according to the present exemplary embodiment, the start-up command that starts the RFIC 3 to execute the ICLC command used for determining the edge trigger is transmitted using each of the rising edge and the falling edge as the edge trigger. Accordingly, in a state where the edge trigger is not yet determined, that is, in a state where it is not apparent which edge to be used as the edge trigger causes a sampling error, it is possible to more certainly start the RFIC 3.

1.5. Modified Example

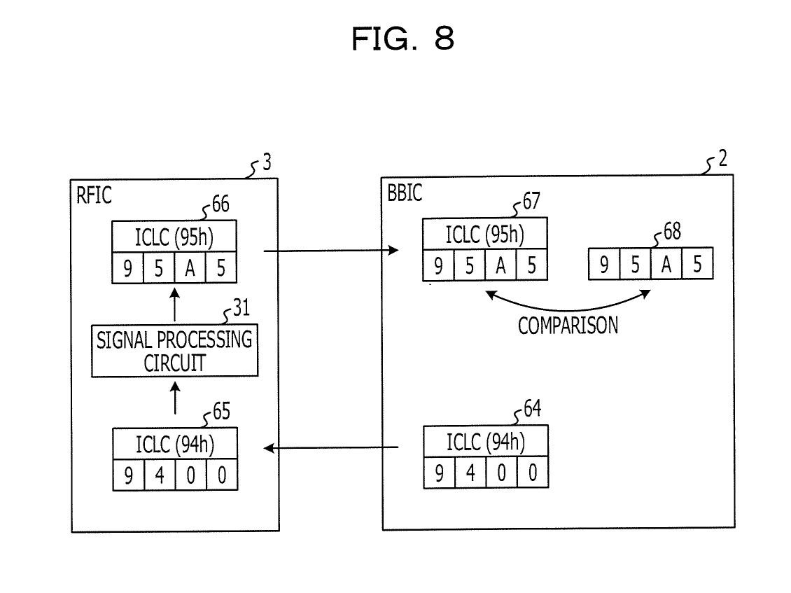

In the determination of the edge trigger, the command that instructs the RFIC 3 to transmit the response signal to the BBIC 2 may be the Ping command. FIG. 8 is a view schematically illustrating a modified example of an edge trigger determination method. The command output unit 50 of the BBIC 2 transmits the ICLC (94h) command 64 to the RFIC 3. Upon receiving the ICLC (94h) command, the signal processing circuit 31 of the RFIC 3 transmits the well-known response signal, i.e., the ICLC (95h) command, to the BBIC 2. The comparison unit 53 compares the signal pattern of the received ICLC (95h) command with the signal pattern of the ICLC (95h) command stored in advance in the memory 13 of the BBIC 2. The edge trigger determining unit 54 determines an edge to be used as the edge trigger based on the result from the comparison unit 53 when each of the rising edge and the falling edge is used as the edge trigger. In the second exemplary embodiment as described below, the Ping command may be used in the same manner.

### 2. Second Exemplary Embodiment

2.1. Hardware Configuration

Continuously, another exemplary embodiment of the electronic circuit 1 will be described. In the present exemplary embodiment, the BBIC 2 transmits a signal in plural times to the RFIC 3 while changing the sampling timing stepwise in the FF 20. Thus, the BBIC 2 detects the amount of change of the sampling timing where an error occurs. The BBIC 2 uses any one of the rising edge and the falling edge of the clock signal CLK2 showing a higher margin in a sampling error as an edge trigger. As a result, it is possible to select a strong edge against a variation of the transmission delay between the BBIC 2 and the RFIC 3.

FIG. 9 is an explanatory view illustrating the hardware configuration of the electronic circuit 1 according to a second exemplary embodiment. The electronic circuit 1 is provided with a switch circuit 80 and a variable load circuit 81. The switch circuit 80 switches the transmission path of the clock signal from the RFIC 3 to the BBIC 2 between a path via the load capacity included in the variable load circuit 81 and a path that bypasses the variable load circuit 81. The processor 12 controls the insertion or the non-insertion of the load capacity by the switch circuit 80, and the load capacity to be inserted in the variable load circuit 81.

2.2. Functional Configuration

FIG. 10 is a functional configuration view illustrating the BBIC 2 according to the second exemplary embodiment. The BBIC 2 is provided with a load control unit 55. The load control unit 55 controls the insertion or the non-insertion of the load capacity by the switch circuit 80, and the load capacity to be inserted in the variable load circuit 81. Since the clock signal CLK2 is delayed according to the amount of inserted load capacity, the sampling timing of the transmission data sampling unit 51 is delayed according to the load capacity.

The edge trigger determining unit 54 sets the rising edge or the falling edge of the clock signal CLK2 as the edge trigger, and changes the capacity of the variable load circuit 81 stepwise to be inserted into the transmission path of the clock signal in each case. For example, the edge trigger determining unit 54 sets the load capacity of the variable load circuit 81 as a plurality of determined values of the load capacity set in advance, thereby changing the load capacity.

The command output unit 50 transmits an ICLC (91h) command and a frame including a predetermined pattern to the RFIC 3 in each of the states where the plurality of different load capacities set by the edge trigger determining unit 54 are inserted. The comparison unit 53 compares the pattern included in a loopback signal transmitted from the RFIC 3 with the pattern included in the frame in each of the states.

If a sampling error has occurred in a state where the load capacity is not inserted, the edge trigger determining unit 54 selects an edge that has not caused the sampling error as the edge trigger, from among the rising edge and the falling edge of the clock signal CLK2.

If no sampling error has occurred at both edges, the edge trigger determining unit 54 detects the variation range of the load capacity where the sampling error occurs in the FF 40, and detects the variation range of the load capacity where the sampling error does not occur in the FF 40. Based on these variation ranges of the load capacity, the edge trigger determining unit 54 determines the deviation amount of the sampling timing in which the sampling timing where the load capacity is not inserted goes away from the center of the sampling timing range where the sampling error does not occur.

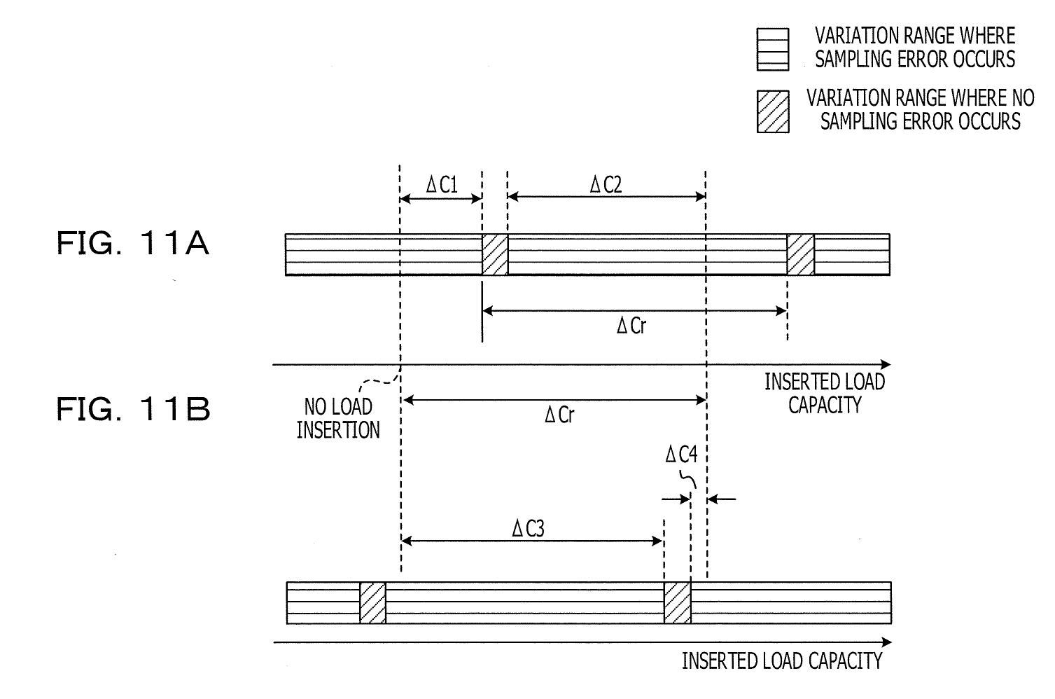

Referring to FIGS. 11A and 11B, one example of a method of determining the deviation amount from the center of the sampling timing range where the sampling error does not occur will be described. Each of FIGS. 11A and 11B illustrates the variation range of the load capacity where the sampling error occurs and the variation range of the load capacity where the sampling error does not occur when each of the rising edge and the falling edge of the clock signal CLK2 is used, respectively.

The edge trigger determining unit 54 calculates the change width ΔCr that corresponds to a load capacity that causes a delay of the sampling timing at one cycle of the clock signal CLK2. The change width ΔCr may be determined by summing up the entire of one continuous variation width where the sampling error occurs, and the entire of another continuous variation width where the sampling error does not occur.

The edge trigger determining unit 54 calculates the load change width ΔC1 and ΔC3 between a state where no load capacity is inserted and the load capacity where the sampling error starts to occur. Also, the differences ΔC2 and ΔC4 between the change width ΔCr and the load capacity where the occurring of the sampling error stops are calculated. The edge trigger determining unit 54 calculates deviation amounts Cu and Cd of the sampling timing by the following equations, respectively, in which each of the deviation amounts goes away from the center of a sampling timing range where the sampling error does not occur when each of the rising edge and the falling edge is used.

Cu=|ΔC1−(ΔC1+ΔC2)/2|

Cd=|ΔC3−(ΔC3+ΔC4)/2|

In the examples of FIGS. 11A and 11B, the deviation amount Cu where the rising edge is used is smaller than the deviation amount Cd where the falling edge is used. Accordingly, the edge trigger determining unit 54 sets the rising edge as the edge trigger.

In this manner, an edge showing a smaller deviation amount away from the center of the sampling timing range where the sampling error does not occur may be used as the edge trigger. Thus, an edge showing a higher margin in a sampling error may be used as the edge trigger. Also, the operation of the load control unit 55 is performed by the processor 12.

2.3. Operation

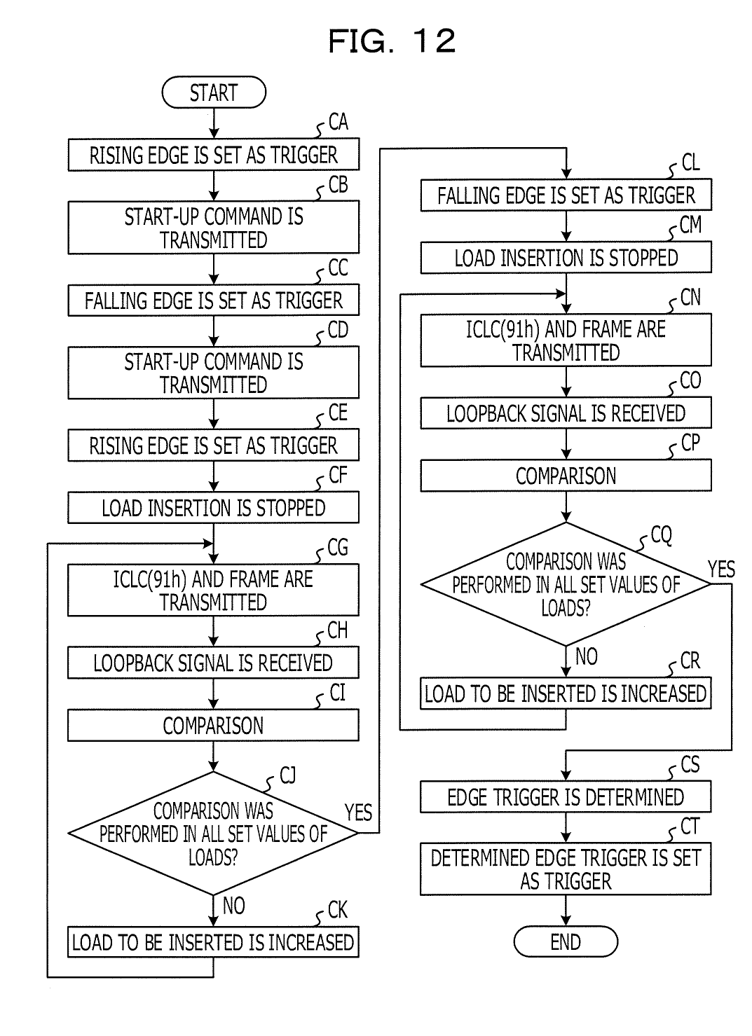

FIG. 12 is a flow chart illustrating a second example of an edge trigger determination method. The operations CA to CD are the same as those in the operations AA to AD in FIG. 6. In the operation CE, the edge trigger determining unit 54 sets the rising edge of the clock signal CLK2 as the edge trigger of the transmission data sampling unit 51.

In the operation CF, the load control unit 55 switches the transmission path of the clock signal to a path that bypasses the variable load circuit 81, and stops the insertion of the load capacity into the transmission path of the clock signal. In the operation CG, the command output unit 50 transmits the ICLC (91h) command to the RFIC 3. The command output unit 50 transmits the frame including the predetermined pattern to the RFIC 3 after the ICLC (91h) command is sent out.

In the operation CH, the receiving unit 52 receives the loopback signal from the RFIC 3. In the operation CI, the comparison unit 53 compares the pattern included in the frame with the pattern included in the loopback signal.

In the operation CJ, the edge trigger determining unit 54 determines whether the transmission of the ICLC (91h) command and the frame is executed, and determines whether the comparison of the pattern included in the frame with the pattern included in the loopback signal have been performed in each of states where all of the predetermined set values of loads are inserted. If the determination in the operation CJ is positive, the operation proceeds to the operation CL. If the determination in the operation CJ is negative, the operation proceeds to the operation CK. In the operation CK, the load control unit 55 increases the load capacity to be inserted into the transmission path of the clock signal, and sets the load capacity as any one of the predetermined set values. Then, the operation proceeds to the operation CG.

In the operation CL, the edge trigger determining unit 54 sets the falling edge of the clock signal CLK2 as the edge trigger of the transmission data sampling unit 51. The operations CM to CR are the same as those in the operations CF to CK.

In the operation CS, the edge trigger determining unit 54 determines any one of the rising edge and the falling edge of the clock signal CLK2 that shows a higher margin in a sampling error as an edge to be used as the edge trigger. The operation CT is the same as that in the operation AN in FIG. 6.

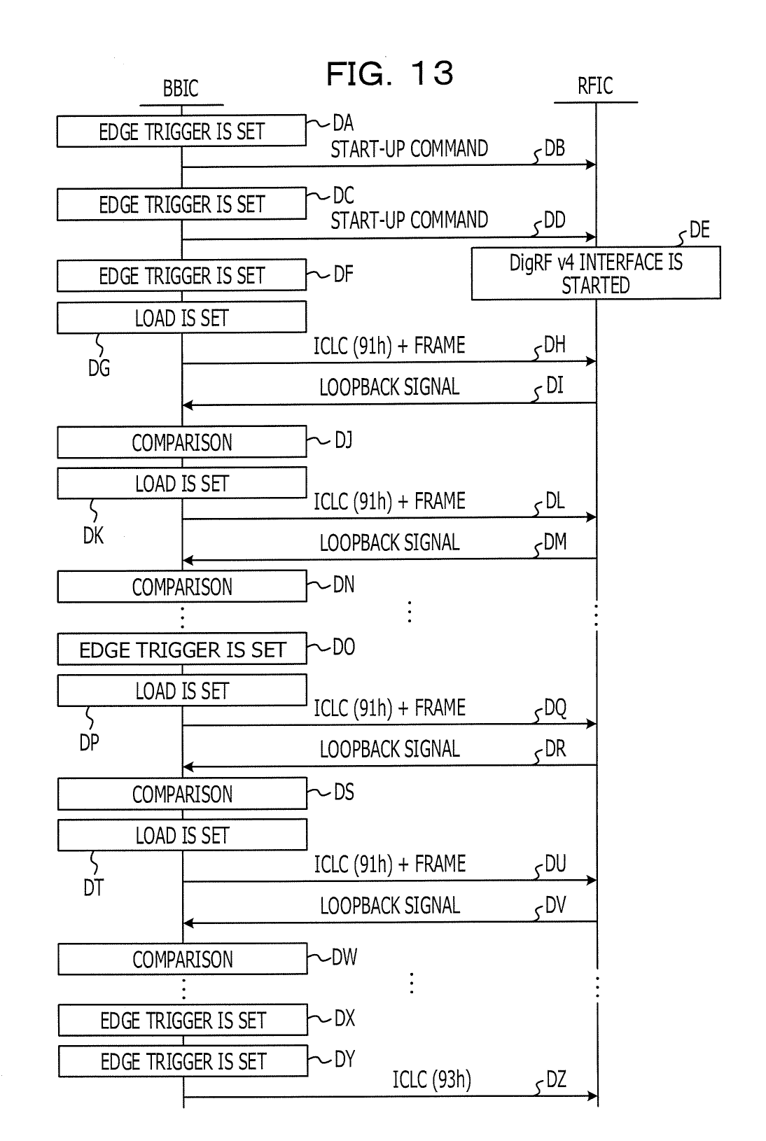

FIG. 13 is an explanatory view illustrating a second example of a signal sequence between ICs. The operations DA to DE are the same as those in the operations BA to BE in FIG. 7. In the operation DF, the edge trigger determining unit 54 sets the rising edge of the clock signal CLK2 as the edge trigger of the transmission data sampling unit 51.

In the operation DG, the load control unit 55 stops the insertion of the load capacity into the transmission path of the clock signal. In the operation DH, the command output unit 50 transmits the ICLC (91h) command and the frame including the predetermined pattern to the RFIC 3. In the operation DI, the RFIC 3 returns back the received frame as it is, as the loopback signal. In the operation DJ, the comparison unit 53 compares the pattern included in the frame with the pattern included in the loopback signal.

In the operation DK, the load control unit 55 increases the insertion of the load capacity into the transmission path of the clock signal. In the operation DL, the command output unit 50 transmits the ICLC (91h) command and the frame including the predetermined pattern to the RFIC 3. In the operation DM, the RFIC 3 transmits the received frame as it is, as the loopback signal. In the operation DN, the comparison unit 53 compares the pattern included in the frame with the pattern included in the loopback signal. The same operations as those in the operations DK to DN are repeatedly performed in each of the states where all of the predetermined set values of loads are inserted, until the transmission of the ICLC (91h) command and the frame, and the comparison of the pattern included in the frame with the pattern included in the loopback signal are performed.

In the operation DO, the edge trigger determining unit 54 sets the falling edge of the clock signal CLK2 as the edge trigger of the transmission data sampling unit 51. In the operation DP, the load control unit 55 stops the insertion of the load capacity into the transmission path of the clock signal. In the operation DQ, the command output unit 50 transmits the ICLC (91h) command and the frame including the predetermined pattern to the RFIC 3. In the operation DR, the RFIC 3 transmits the received frame as it is, as the loopback signal. In the operation DS, the comparison unit 53 compares the pattern included in the frame with the pattern included in the loopback signal.

In the operation DT, the load control unit 55 increases the insertion of the load capacity into the transmission path of the clock signal. In the operation DU, the command output unit 50 transmits the ICLC (91h) command and the frame including the predetermined pattern to the RFIC 3. In the operation DV, the RFIC 3 transmits the received frame as it is, as the loopback signal. In the operation DW, the comparison unit 53 compares the pattern included in the frame with the pattern included in the loopback signal. The same operations as those in the operations DT to DW are repeatedly performed in each of the states where all of the predetermined set values of loads are inserted, until the transmission of the ICLC (91h) command and the frame, and the comparison of the pattern included in the frame to the pattern included in the loopback signal are performed.

In the operation DX, the edge trigger determining unit 54 determines an edge to be used as the edge trigger. The operations DY and DZ are the same as those in the operations BO and BP in FIG. 7.

2.4. Effect

According to the present exemplary embodiment, any one of the rising edge and the falling edge of the clock signal CLK2 that shows a higher margin in a sampling error may be used as the edge trigger. As a result, it is possible to further reduce the sampling error in a receiver side circuit caused by the difference between a period time of sampling and a time period of edge generation of the reception signal.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An electronic circuit comprising:
a memory; and
a processor coupled to the memory, configured to
sample a transmission signal at an edge timing of a pulse of a clock signal for synchronizing with a counterpart electronic circuit,
transmit a sampled transmission signal to the counterpart electronic circuit,
receive a response signal sent from the counterpart electronic circuit in response to the sampled transmission signal, and
set any one of a rising edge and a falling edge of the clock signal as an edge trigger for a sampling timing of the sampling according to a reception result of the response signal.

2. The electronic circuit according to claim 1,
wherein the processor is configured to change the sampling timing of sampling stepwise, and set, as the edge trigger, any one of the rising edge and the falling edge of the clock signal that shows a higher margin in a sampling error of the transmission signal generated in the counterpart electronic circuit by a change in the sampling timing.

3. The electronic circuit according to claim 2, wherein the processor is configured to set, as the edge trigger, any one of the rising edge and the falling edge of the clock signal showing a smaller deviation amount from the center of a sampling timing variation range where the sampling error does not occur.

4. The electronic circuit of claim 2, wherein the processor is configured to insert a variable load capacity to a transmission path configured to transmit the clock signal.

5. The electronic circuit of claim 1, wherein the processor is configured to transmit a command that requests a transmission of the response signal to the counterpart electronic circuit.

6. The electronic circuit of claim 5, wherein the command instructs the transmission signal transmitted to the counterpart electronic circuit to be returned as the response signal.

7. The electronic circuit of claim 5, wherein the command instructs a well-known signal to be transmitted as the response signal.

8. A communication method comprising:
sampling a transmission signal at an edge timing of a pulse of a clock signal for synchronizing an electronic circuit with a counterpart electronic circuit;
transmitting a sampled transmission signal to the counterpart electronic circuit;
receiving a response signal sent from the counterpart electronic circuit in response to the sampled transmission signal; and
setting, by a processor, any one of a rising edge and a falling edge of the clock signal as an edge trigger for a sampling timing of the transmission signal according to a reception result of the response signal.

9. The communication method according to claim 8, further comprising:
changing the sampling timing of sampling stepwise,
wherein the setting includes setting, as the edge trigger, any one of the rising edge and the falling edge of the clock signal that shows a higher margin in a sampling error of the transmission signal generated in the counterpart electronic circuit by the changing in the sampling timing.

10. The communication method according to claim 9, wherein
the setting includes setting, as the edge trigger, any one of the rising edge and the falling edge of the clock signal showing a smaller deviation amount from the center of a sampling timing variation range where the sampling error does not occur.

11. The communication method of claim 9, wherein
the changing includes inserting a variable load capacity to a transmission path configured to transmit the clock signal.

12. The communication method of claim 8, further comprising:
transmitting a command that requests a transmission of the response signal to the counterpart electronic circuit.

13. The communication method of claim 12, wherein the command instructs the transmission signal transmitted to the counterpart electronic circuit to be returned as the response signal.

14. The communication method of claim 12, wherein the command instructs a well-known signal to be transmitted as the response signal.

15. A radio communication device comprising:
a first electronic circuit configured to perform radio frequency processing; and
a second electronic circuit configured to
sample a transmission signal at an edge timing of a pulse of a clock signal for synchronizing with the first electronic circuit,
transmit a sampled transmission signal to the first electronic circuit,
receive a response signal sent from the first electronic circuit in response to the sampled transmission signal, and
set any one of a rising edge and a falling edge of the clock signal as an edge trigger for a sampling timing of the sampling according to a reception result of the response signal.
